(19) United States
(12) Patent Application Publication
(10) Pub. No.: US 2009/0237821 A1
(43) Pub. Date: Sep. 24, 2009

(54) REAR MIRROR OF VEHICLE HAVING DISPLAY

(76) Inventor: Shin-Nan Li, Taipei (TW)

Correspondence Address: Shin-Nan LI, 235 Chung - Ho Box 8-24, Taipei, 235, TW

(21) Appl. No.: 12/050,179

(22) Filed: Mar. 18, 2008

(51) Int. Cl. G02B 5/08

(52) U.S. Cl. 359/844; 359/842

(57) ABSTRACT

A rear mirror of a vehicle having a display includes a seat having a dynamic unit at one side thereof; the dynamic unit being connected to a power source through a power; a body having a display unit; the body being slideable along the seat; one side of the body being installed with a teeth strip engageable with a gear of the dynamic unit; and a mirror body having a mirror surface installed at a front side of the seat. When the body slides inwards, the mirror body can be hidden between the mirror body and the seat; and when the body slides outwards, the mirror body protrudes out of the mirror body.

### FIELD OF THE INVENTION

The present invention relates to vehicle rear mirrors, and particularly to a rear mirror of a vehicle having a display, which is controlled by a dynamic unit.

### BACKGROUND OF THE INVENTION

With the advance of technology and the trend that the display is thinner and thinner, the rear mirrors of a vehicle are installed with display unit (such as thin liquid crystal display). The display can provide the function of satellite navigation, data transformation, A/V multimedia playing, and other application, moreover, the function of image capturing in back of a car is also provided. In the prior art, the combination of display and rear mirror are combined by folding the display or rotating the display to be at the backside of the rear mirror. In use, the display is unfolded or rotated out to be viewed. In one improvement, the rear mirror is installed with a retracting unit which is fixed with a display so that the display can be hidden within the rear mirror of the vehicle. In use, the retracting device will retract the display.

In above mentioned structure, the folding and rotating operation is performed manually, or the display is retracted by the retracting device. However the whole structure is not steadily and the sliding guiding device is not idea so that the positioning of the whole structure is not smooth. Furthermore, the vibration of the vehicle will affect the viewing quality and the lifetime of the structure. Thus in U.S. Pat. No. 7,175,281, a track and a rack are used to guide the structure. Furthermore, teethed strip and gear are engaged to provide damping effect to improve the steadiness and smoothness in sliding. Furthermore, tenons and buckles are used to lock the structure. Elastic force of a compressible spring cause that in operation, it is only ejected outwards slightly. The tenons and buckles can be released. Furthermore, the display is pushed downwards by the elastic force so as to improve the defects of manual operation.

However in the prior art, the structure of the tenons and buckles are complicated and the cost in manufacturing and assembly is high. The expansion of the display must be performed manually. It is not a humanized operation. Thus a novel power saving and simple operation design is necessary.

### SUMMARY OF THE INVENTION

Accordingly, the object of the present invention is to provide a rear mirror of a vehicle having a display which has a simple structure and assembly. A sliding and positioning unit between the body and seat is simpler so as to reduce the cost in assembly. Further, the dynamic unit is operated by a remote controller or a touch switch instead of manual operation. Thus the present invention provides the function of easy operation and manpower saving.

To achieve above object, the present invention provides a rear mirror of a vehicle having a display, comprising:

A seat having a dynamic unit at one side thereof; the dynamic unit being connected to a power source through a power;

A body having a display unit; the body being slideable along the seat; one side of the body being installed with a teeth strip engageable with a gear of the dynamic unit; and

A mirror body having a mirror surface installed at a front side of the seat; when the body slides inwards, the mirror body can be hidden between the mirror body and the seat; when the body slides outwards, the mirror body protrudes out of the mirror body.

A sliding guiding device is installed between a front wall of the seat and a rear wall of the body.

The sliding guiding device includes a guide rod and a rack at two lateral sides of a front wall of the seat; and a sliding block and a track at two lateral sides of a right side the body; the sliding block has a through hole for receiving the guide rod so that the sliding block is moveable along the guide rod; and the track is engageable to rack of the seat so that the seat is movable along the track.

The seat has an embedding groove and the dynamic unit is installed in the embedding groove.

The seat aside the body is installed with a detection element, when the dynamic unit of the seat moves to a predetermined position, the detection element will actuate and control the power supply of the detection element.

The detection element is a sensor photoelectric switch.

The detection element is controlled by a wireless remote controller.

The detection element is controlled by a touch switch.

The dynamic unit is controlled by a wired far end controller.

The mirror body further includes a digital camera lens.

The seat is installed with a speed detector.

The various objects and advantages of the present invention will be more readily understood from the following detailed description when read in conjunction with the appended drawing.

### BRIEF DESCRIPTION OF THE DRAWINGS

FIG. 1 is an exploded perspective view of the rear mirror of the present invention.

FIG. 2 is a rear view of the body of the present invention.

FIG. 3 is a structural schematic view showing that the body of the present invention is within a seat.

FIG. 4 is a schematic view showing the extension operation of the seat according to the present invention (where the mirror body is not illustrated).

FIG. 5 shows the application of the present invention, where the body protrudes to be below the mirror body.

FIG. 6 shows the application of the present invention, where the present invention is in a hidden state.

### DETAILED DESCRIPTION OF THE INVENTION

In order that those skilled in the art can further understand the present invention, a description will be provided in the following in details.

However, these descriptions and the appended drawings are only used to cause those skilled in the art to understand the objects, features, and characteristics of the present invention, but not to be used to confine the scope and spirit of the present invention defined in the appended claims.

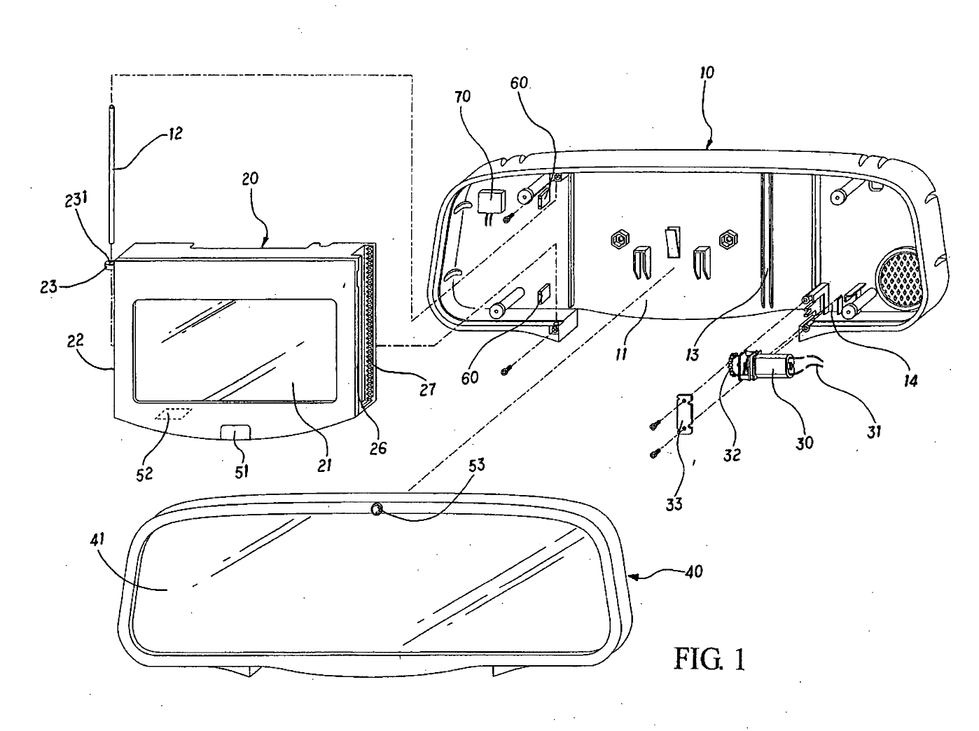

Referring to FIG. 1, the rear mirror of a vehicle with a display of the present invention is illustrated, which includes the following elements.

A seat 10 serves for installing an original rear mirror (not shown) at a front lateral side and aside a front wind glass of a vehicle. The seat 10 can be used to replace the original rear mirror of a vehicle. A left side of a front wall 11 of the seat 10 is installed with a vertical guide rod 12. A right side of the front wall 11 thereof is formed with a rack 13. One side of the seat 10 has an embedding groove 14 for installing a dynamic unit 30.

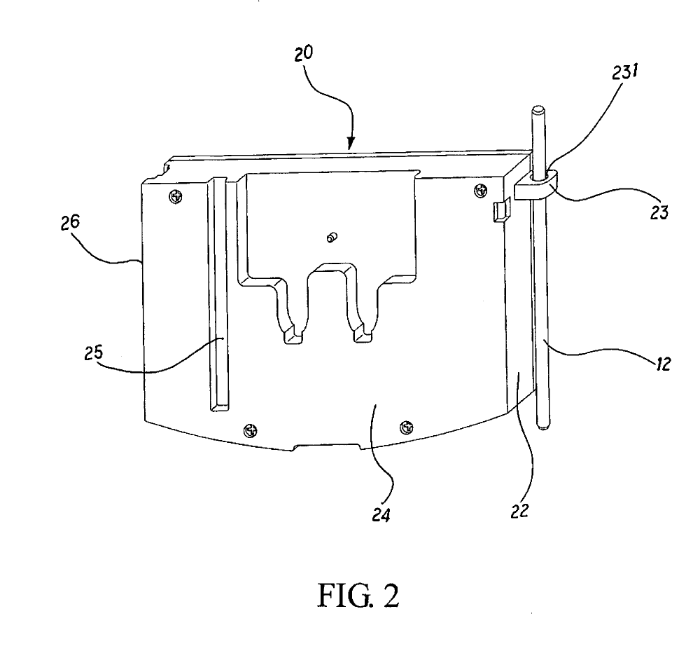

Referring to FIG. 2, a body 20 has a display unit 21 installed at an inner side thereof. The display unit 21 can be viewed from a front side thereof. A left wall 22 of the body 20 is protruded with a sliding block 23. A through hole 231 penetrates through the sliding block 23 for receiving the guide rod 12 of the seat 10 so that the sliding block 23 can slide along the guide rod 12 longitudinally and limitedly. Besides, a rear wall 24 of the body 20 has a track 25 at a position with respect to the rack 13 of the seat 10. The track 25 may receive the rack 13 and thus the rack 13 is slideable along the track 25 so as to form as a sliding guiding assembly. A rear wall 24 of the body 20 has a teeth strip 27.

Preferably, the dynamic unit 30 is a small motor and is installed at one side of the seat 10. The dynamic unit 30 is powered by a wire 31. An output end of the dynamic unit 30 is connected to a gear 32. The dynamic unit 30 can be embedded into the embedding groove 14 of the seat 10. The gear 32 is engaged to the teethed strip 27 of the body 20 and is pressed by a press plate 33 to be positioned.

A mirror body 40 is installed at a front side of the seat 10 and has a mirror surface 41. A space is formed between the mirror body 40 and the seat 10. Besides, when the body 20 is pushed by the dynamic unit 30 to slide downwards, it exactly protrudes from a lower side of the mirror body 40. Therefore, the user can view of the display unit 21 of the body 20.

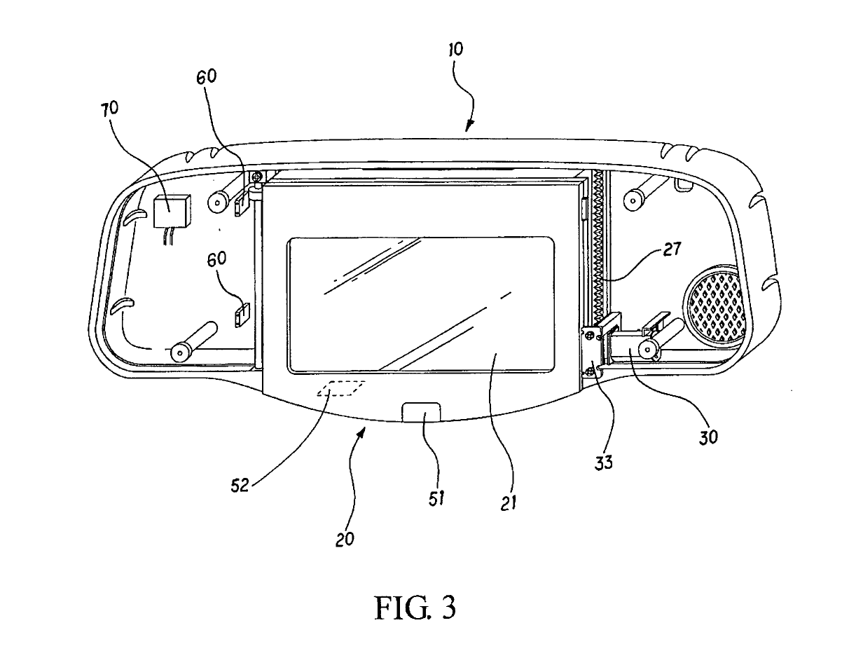

It should by noted that as shown in FIGS. 1 and 3, the dynamic unit 30 on the seat 10 of the present invention includes many different operation ways. A first one is to operate it remotely through wireless control. It may be an infrared remote control. In this embodiment, a lower side of the body 20 is installed with a wireless receiver 51 and a wireless remote controller matched to the wireless receiver 51 (not shown). By operating the wireless remote controller, the wireless receiver 51 will receive infrared signals. Then the dynamic unit 30 is controlled to switch and operate so as to have the function of pushing the body 20 to slide and displace. The second way is a touch control way. In this embodiment, a lower side of the body 20 is installed with a touch switch 52. In operation, it is only necessary to touch the touch switch 52, the dynamic unit 30 can be controlled directly. The third way is a far end wired control. In this embodiment, a mainframe (not shown) with a touch switch or wireless remote control function is included. The mainframe is installed at a predetermined position within a vehicle. The mainframe is connected to the dynamic unit 30 by wires. Therefore, the touch switch 52 or wireless remote controller in the mainframe can be used to control the actuation of the dynamic unit 30. The above mentioned three ways may be used to control the dynamic unit 30 easily.

Besides, the present invention further provides other extra functions, and particularly to the mirror body 40. A front upper side of the mirror body 40 may be added with a digital camera lens 53 for capturing images real time no matter the vehicle moves or is motionless. The images from the digital camera lens 53 can be transferred by satellites so as to have the function of burglar proof.

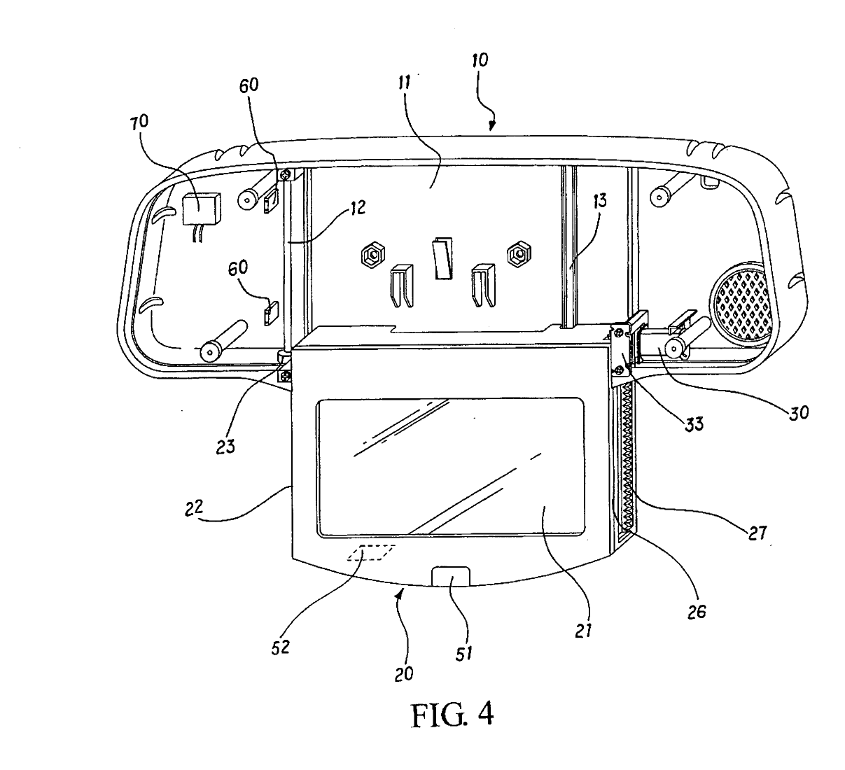

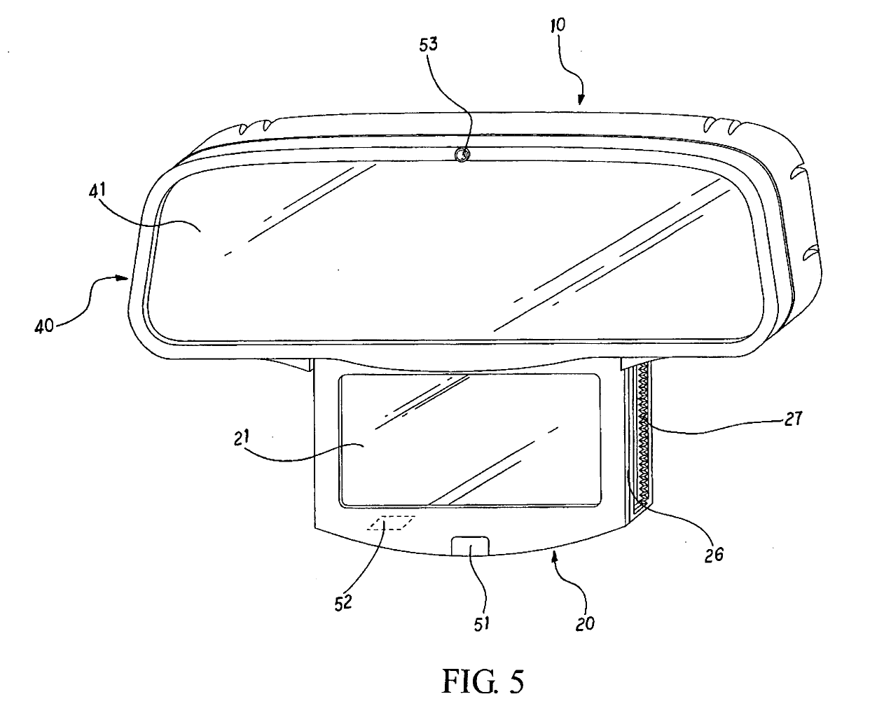

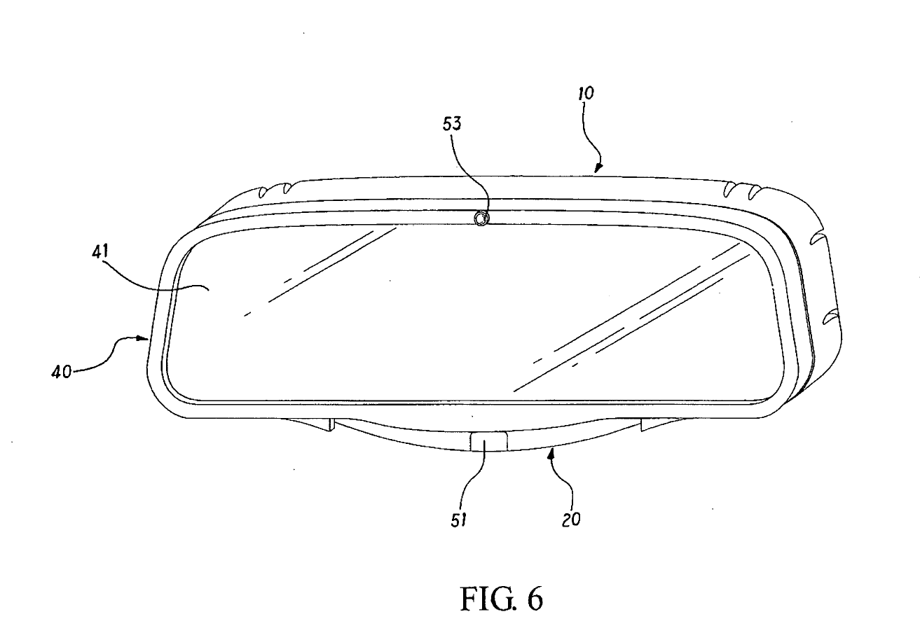

Referring to FIGS. 3 and 4, in the rear mirror with a display according to the present invention, the seat 10 can be installed on a rear mirror of a vehicle. Normally, as it is not used, the body 20 having the dynamic unit 30 can be hidden between the mirror body 40 and the seat 10. Thus it has an outlook approximately identical to the original rear mirror of the vehicle. Thus, the user can view the mirror surface 41 of the mirror body 40 directly to know the rear view of the vehicle. When the user desires to view the display unit 21, the user can actuate the dynamic unit 30 by above mentioned wireless remote controller, touch switch 52 or the far end wire controller. The gear 32 of the dynamic unit 30 will rotate to drive the teeth strip 27 to push the body 20 to slide out with respect to the seat 10 so as to protrude out from the lower side of the mirror body 40 (referring to FIGS. 5 and 6) so that the user can view the image data from the display unit 21. Besides, when the user desires to hid the body 20 in the interior of the seat 10, the user only needs to press the wireless remote controller, touch switch 52 or the far end wire controller to actuate the dynamic unit 30 to revert so as to drive the body 20 to hid into the body 20 at the rear side of the mirror body 40. Of course, no matter the body 20 protrudes downwards or stored upwards, in the sliding process, the sliding guiding assembly between the body 20 and the seat 10 is helpful to precisely limit the sliding effect.

Moreover, one side of the seat 10 can be installed with a detection element 60 and a speed detector 70. The detection element 60 is a sensor photoelectric switch. The detection element 60 has two sensors (formed as a set) which are installed at predetermined positions at the uppermost traveling path and at the lowermost traveling path so as to detect the displacement of the body 20 and send out signals. Then the dynamic unit 30 is further controlled through the wires so as to stop the operation. By above mentioned ways, the control can be performed easily and automatically and the safety of the dynamic unit 30 is protected. The speed detector 70 has the effect of providing information to user for speed limitation so as to achieve the object of safety driving.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A rear mirror of a vehicle having a display, comprising:
a seat having a dynamic unit at one side thereof; the dynamic unit being connected to a power source through a power;
a body having a display unit; the body being slideable along the seat; one side of the body being installed with a teeth strip engageable with a gear of the dynamic unit; and
a mirror body having a mirror surface installed at a front side of the seat; when the body slides inwards, the mirror body can be hidden between the mirror body and the seat; when the body slides outwards, the mirror body protrudes out of the mirror body.

2. The rear mirror of a vehicle having a display as claimed in claim 1, wherein a sliding guiding device is installed between a front wall of the seat and a rear wall of the body.

3. The rear mirror of a vehicle having a display as claimed in claim 2, wherein the sliding guiding device includes a guide rod and a rack at two lateral sides of a front wall of the seat; and a sliding block and a track at two lateral sides of a right side the body; the sliding block has a through hole for receiving the guide rod so that the sliding block is moveable along the guide rod; and the track is engageable to rack of the seat so that the seat is movable along the track.

4. The rear mirror of a vehicle having a display as claimed in claim 1, wherein the seat has an embedding groove and the dynamic unit is installed in the embedding groove.

5. The rear mirror of a vehicle having a display as claimed in claim 4, wherein the seat aside the body is installed with a detection element, when the dynamic unit of the seat moves to a predetermined position, the detection element will be actuated and control the power supply of the detection element.

6. The rear mirror of a vehicle having a display as claimed in claim 5, wherein the detection element is a sensor photoelectric switch.

7. The rear mirror of a vehicle having a display as claimed in claim 1, wherein the detection element is controlled by a wireless remote controller.

8. The rear mirror of a vehicle having a display as claimed in claim 1, wherein the detection element is controlled by a touch switch.

9. The rear mirror of a vehicle having a display as claimed in claim 1, wherein the dynamic unit is controlled by a wired far end controller.

10. The rear mirror of a vehicle having a display as claimed in claim 1, wherein the mirror body further includes a digital camera lens.

11. The rear mirror of a vehicle having a display as claimed in claim 1, wherein the seat is installed with a speed detector.
